(19) United States
(12) Patent Application Publication
(10) Pub. No.: US 2012/0111806 A1
(43) Pub. Date: May 10, 2012

(54) PULSED SLUDGE BED SETTLING METHOD AND DEVICE

(75) Inventors: Chrystelle Langlais, Le Pecq (FR); Jean Lois Vital, Le Pecq (FR)

(73) Assignee: Degremont, Rueil-Malmaison (FR)

(21) Appl. No.: 13/376,639

(22) PCT Filed: Jun. 3, 2010
(86) PCT No.: PCT/IB2010/052473

§ 371 Date: Jan. 12, 2012

(30) Foreign Application Priority Data
Jun. 8, 2009 (FR) 09 02760

(51) Int. Cl. B01D 21/00

(52) U.S. Cl. 210/800; 210/121

(57) ABSTRACT

The invention relates to a pulsed sludge bed settling method for treating all types of liquid, in particular water, and which uses at least one powder or grain reactant, according to which: the liquid and the reactant(s) for the treatment are contained in a tank (1) comprising, at the base thereof, a means (2) for uniformly feeding liquid to be treated over the entire surface thereof; the treated liquid is discharged into the top portion of the tank, at the top level (S) of the liquid; the liquid to be treated is supplied into the tank by pulsations, inducing alternating vertical movements of the sludge bed (M); and part of the sludge is spilled into a concentrator (12) when the top level of the sludge bed exceeds a spilling level (Ld). The amplitude of the alternating vertical movements of the sludge bed (M) is varied between at least two values: one of said values corresponds to a high sludge bed level (Nh2) that is lower than the spilling level (Ld), and the other of said values corresponds to a high sludge bed level that is higher than the spilling level (Ld), with the discharge of the sludge and the reactant.

The invention relates to a settling method using a pulsed sludge bed for the treatment of any type of liquid, particularly water, employing at least one powdered or granular reactant, said method being of the kind of those in which:
the liquid undergoing treatment and the reactant(s) are contained in a tank comprising, at the base thereof, means for uniformly injecting liquid to be treated;
the liquid is fed into the tank by pulses causing alternating vertical movements of the sludge bed;
the treated liquid is discharged at the upper level of the liquid in the tank; and
when the upper level of the raised sludge bed exceeds a spillover level, a portion of this sludge is discharged into a concentrator.

The invention relates to an improvement to such a settling method. The term “sludge bed” denotes a relatively concentrated suspension in which pollutants and reactants are brought together under the action of said reactants.

A method of this kind is known in particular from the patent FR 1 115 038 by the applicant company, which discloses an up-flow pulsed-sludge-bed settler comprising a bell provided with a suction device or vacuum pump for varying the liquid level in the bell and thus enabling the instantaneous ascensional velocity in the tank to vary between a velocity V₀ and a velocity V₁. The expression “ascensional velocity” used in the description denotes the ascensional velocity of the liquid in the zone in question of the tank (i.e. volume flow rate divided by the surface area), that is to say the velocity of the water phase.

The applicant company also holds the following patents:
FR 2 196 832, which discloses an improvement to the settler by adding tubes or plates inclined to the horizontal within the sludge bed, making it possible to increase the maximum ascensional velocity and/or to improve the quality of the treated water;
FR 2 132 954 which discloses another improvement to the settler by adding lamellar modules above the sludge bed for a similar result; and
EP 0 423 964 which discloses the combined use of plates within the sludge bed and of lamellar modules above the sludge bed.

This family of settlers and reactors is also described in the 9^{th} edition of Degrémont's “Memento Technique de l'Eau”, pages 661 to 666.

In the sludge-bed settling method, the liquid to be treated, especially water, to which appropriate reactants (coagulants, pH correctors, polymer, active carbon or other adsorbents, ion-exchange resins, etc.) have been added, flows upward through the layer of sludge acting by contact with the water. This promotes agglomeration of the precipitates formed and/or of the added materials, which are retained within the layer of sludge at the same time as the fine suspended particles contained in the liquid to be treated.

The liquid to be treated is injected into the tank, at the base thereof, with a uniform flow rate or with desirable flow rates, as explained in the applicant's patents mentioned above.

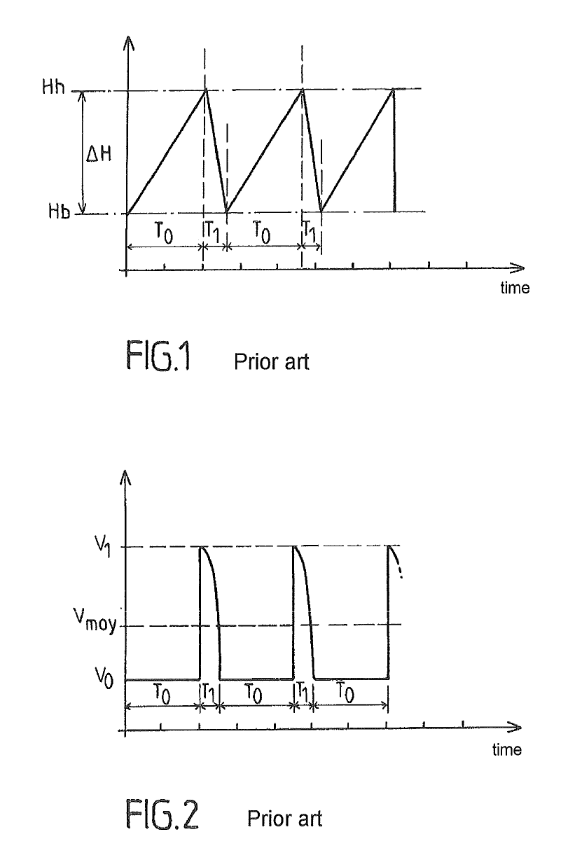

All the devices embodying the same settling method defined above have:
a bell-filling time T₀;
an expulsion time T₁; and
a drop in height ΔH between a high level Hh and a low level Hb within the bell, enabling the instantaneous ascensional velocity in the tank to be varied between V₀ and V₁ about an apparent average ascensional velocity over the course of time. FIGS. 1 and 2 of the appended drawings illustrate these variations. In FIG. 1, the liquid height in the bell is plotted on the y-axis, while the time is plotted on the x-axis. In FIG. 2, the instantaneous ascensional velocity is plotted on the y-axis, while the time is plotted on the x-axis.

The values T₀, T₁ and ΔH are determined for intermittently obtaining an ascensional velocity V₁ which is above the settling velocity of the sludge bed but remains below the entrainment velocity of the sludge bed.

In the case of clarification by coagulation/settling, these values are generally within the following ranges:
T₀: from 20 to 40 s;
T₁: from 5 to 20 s;
ΔH: from 0.6 to 1 m in order to generate velocities V₁ for obtaining a 20 to 40% volume expansion of the sludge bed, while still preventing preferential passages that may damage the effectiveness of the reactor.

The sludge bed thus undergoes alternating vertical movements also called sludge bed “breathing”.

A certain zone of the device or reactor is reserved for forming at least one trench, in particular one having an inclined bottom, called a concentrator, into which a fraction of the sludge spills over semicontinuously when, under the pulse of the velocity V₁, the level of the sludge bed rises above the spillover level of the concentrator. The sludge is concentrated therein and subsequently extracted therefrom. At each pulse, the level of the sludge bed exceeds the spillover level and a portion of the sludge passes into the concentrator.

The operation described above involves a direct relationship:
between the velocity V₁, that is to say the dissipated energy, and the upper level of the sludge bed; and
the amounts of sludge bed spilled over into the concentrator, that is to say the amounts of sludge extracted.

The residence time of the reactant in the settling device is tied to the velocity V₁ and to the parameters T₀, T₁ and ΔH, thereby preventing an optimal value for the residence time to be chosen according to be chosen according to the type of reactant.

In the case of the use of a single treatment reactant, the use of a sludge bed in a settling device as described above requires a fixed ascensional energy to implement the expansion, ensuring homogenization of the sludge bed and spillover of a portion of the sludge bed into the concentrator. The residence time of the particles, especially of the reactant, in the reaction zone, is then determined—this residence time may differ from the optimal time for exploiting the reactant.

In particular, if the reactant consists of powdered active carbon having given properties, it will not be possible for the residence time of the reactant in the settling device to be widely varied in order to use its maximum adsorption capacity and to increase its concentration in the reactor. This limits the possibility of reducing reactant consumption and the operating costs.

If a plurality of reactants, especially differing in size and density, is used, the lack of optimization is even greater. This is because a single set of parameters T₀, T₁ and ΔH cannot be suitable for all reactants. Furthermore, the extraction of the least expansible reactants causes massive extraction of the most expansible reactants or even entrainment of these reactants into the treated effluent.

The object of the invention is, above all, to make improvements to the pulsed-sludge-bed settling method defined above and to optimize the use of the reactant(s).

Another object of the invention is to enable a plurality of reactants to be advantageously, reliably and safely employed.

The present invention was also set the following objectives:
to improve the quality of the treated water;
to reduce the reactant doses and thus reduce the operating costs;
to control the residence time of the reactant(s) within the sludge bed;
to make the settling device reliable by increasing its buffering capability;
to provide greater flexibility in its operation;
to allow, at least in part, selective extraction of the spent reactants, permitting selective management, and therefore potentially optimizing the spent reactants technically (by recycling/regeneration, destruction);
to reduce the spent reactant management costs; and
thus, more generally, to reduce the environmental impact due to the use of reactants and the treatment.

To do so, according to the invention, a settling method using a pulsed sludge bed, of the type defined above, is characterized in that the amplitude of the alternating vertical movements of the sludge bed is varied between at least two values, one of these values, which is relatively low, corresponding to a high sludge bed level below the spillover level, which ensures homogenization of the sludge bed and of the liquid to be treated, and the other of these values, which is relatively high, corresponding to a high sludge bed level above the spillover level which ensures extraction of part of the sludge and of the reactant.

Thus, the invention aims to dissociate the sludge bed homogenization function, which mainly corresponds to the consumed energy, from the sludge bed extraction function, which mainly corresponds to the residence time of the reactants.

The invention employs, in a given device, several sets of parameters specifically producing, in alternation:
pulses for homogenizing the sludge bed, or the successive zones constituting the sludge bed; and
pulses for entrainment of the sludge and their spillover into one or more concentrators.

It is possible to employ a plurality of concentrators with different spillover levels in order to create various reactive zones and the sludge from the various reactive zones is recovered selectively.

The invention also relates to a settling device using a pulsed sludge bed, implementing the method defined previously, and characterized in that the control means is designed to vary at least the drop in height in the bell and to give it at least two values, the lower value of which ensures that the sludge bed is raised to a level (Nh2) below the spillover level (Ld) and there is no discharge of sludge and reactant, whereas the higher value ensures that the sludge bed is raised to a level (Nh1) equal to or above the spillover level (Ld) and that there is discharge of sludge and reactant.

Advantageously, the control means is designed to control:
n filling times of the bell (T₀₁ . . . T₀ₙ);
n expulsion times (T₁₁ . . . T₁ₙ);
n drops in height (ΔH1 . . . ΔHn) within the bell; and
n pulsing frequencies.

The settling device may comprise a plurality of concentrators with different spillover levels for selectively recovering the sludge from various reactive zones.

The control means may be programmed to define four pulse types:
a “moderately intense” pulse, for homogenizing a reactive zone, consisting of a mixture of the reactants (R1, R2), and for varying the upper sludge bed level (Nh2.1) without reaching the level (Ld1) of the associated spillway, and without the upper level (Nh2.2) of the other reactive zone (Z2) reaching the level (Ld2) of the associated spillway;
a “less-intense” pulse for homogenizing the other reactive zone (Z2) and for varying the upper level (Nh2.2) of this reactive zone (Z2), without reaching the level (Ld2) of the associated spillway;
an “intense” pulse for raising the upper level (Nh2.2) of the reactive zone (Z2) above the level (Ld2) of the associated spillway so that the reactant (R2) selectively spills over into the associated concentrator; and
a “very intense” pulse for raising the upper level (Nh2.1) of the reactive zone (Z1) above the level (Ld1) of the associated spillway so that a mixture of reactants (R1, R2) spills over into the associated concentrator.

The control means may be programmed to apply a pulse generating an ascensional velocity above the entrainment velocity of the reactant so that this reactant is entrained in the treated effluent, the reactant then being retained by filtration on a membrane, so that the reactant is selectively extracted and concentrated.

The settling device may include recycling means in the tank, or upstream thereof, for recycling the sludge coming from the concentrator(s).

The invention may thus be characterized by the definition of:
n filling times (T₀₁ . . . T_{0N});
n expulsion times (T₁₁ . . . T_{1N});
n drops in height (ΔH1 . . . . ΔHn) within the bell; and
n pulsing frequencies thus termed.

It is thus possible:
to vary, at will, the frequency of the pulses and the intensity or overvelocity within the reactor during pulses;
to apply pulses exclusively dedicated to homogenization of the sludge bed without sludge spillover into the concentrator;
to vary, over the course of time, the upper level of the sludge bed or of the reactive zones relative to the concentrator spillover level and to permit sludge spillover at discrete times, that is to say not continuously or semicontinuously, but discontinuously.

A variable intake rate into the bell may be provided.

The invention consists, apart from the arrangements explained above, of a certain number of other arrangements which will be more explicitly discussed hereinbelow in conjunction with embodiments which are described with reference to appended drawings but are in no way limiting. In these drawings:

FIG. 1 is a diagram illustrating the variation in liquid height in the bell, plotted on the y-axis, as a function of the time, plotted on the x-axis, according to the prior art in a pulsed reactor;

FIG. 2 is a diagram illustrating the variation in the instantaneous ascensional velocity, plotted on the y-axis, as a function of the time, plotted on the x-axis, according to the prior art;

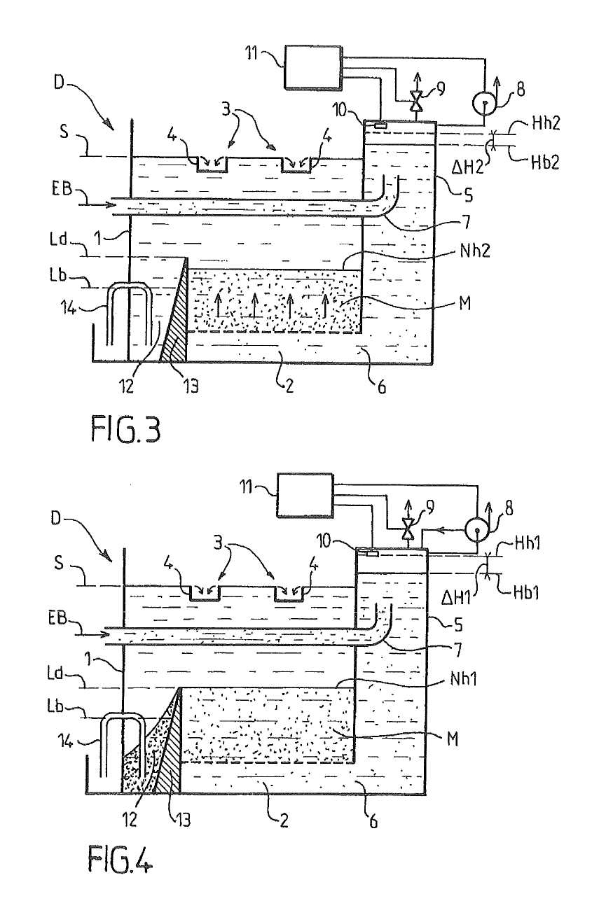

FIG. 3 is a schematic vertical cross section through a settling device according to the invention during a homogenization phase with no spillover;

FIG. 4 shows, again in vertical cross section, the settling device of FIG. 3 in a spillover phase, with a lowering in the level of the bell by ΔH1 greater than that of FIG. 3;

FIG. 5 is a diagram, similar to that of FIG. 1, illustrating the variation in the height in the bell of the device according to FIG. 3 as a function of the time plotted on the x-axis;

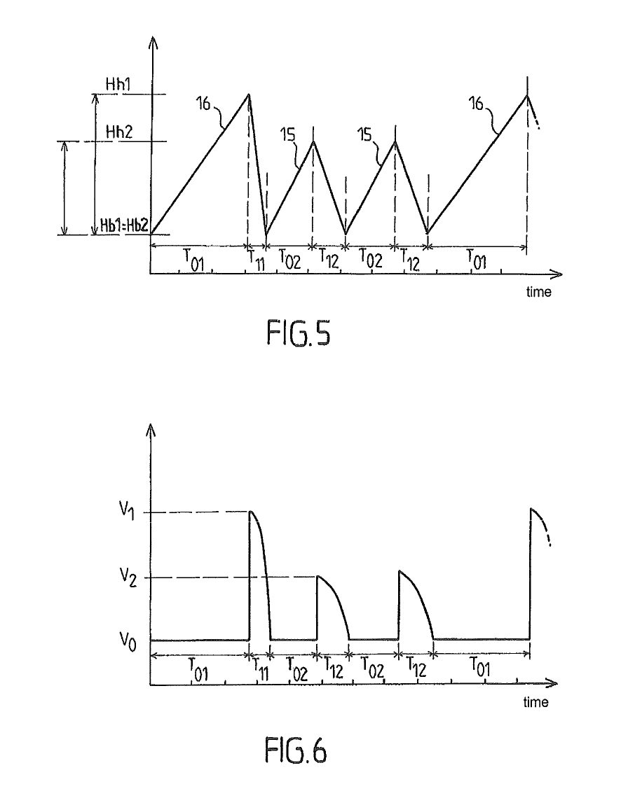

FIG. 6 is a diagram illustrating the variation in the instantaneous ascensional velocity, according to the device of FIG. 3, as a function of the time plotted on the x-axis; and

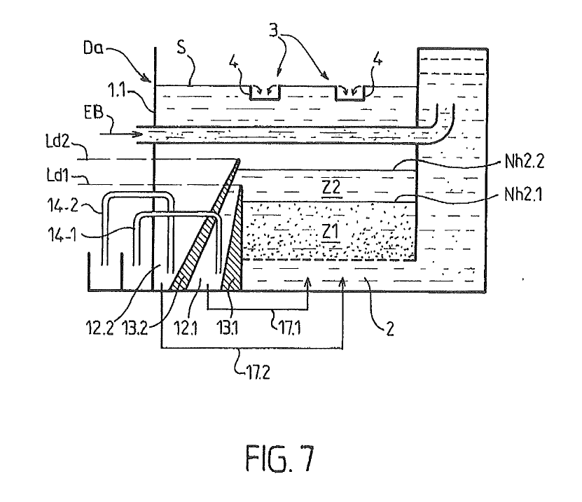

FIG. 7 is a schematic vertical cross section through a settling device according to the invention with two concentrators.

FIG. 3 of the drawings shows a settling device D according to the invention, which comprises a tank 1, preferably having a flat bottom, provided in the base thereof with means 2 for uniformly injecting liquid to be treated EB. In the example in question, the liquid EB is raw water. The means 2 are not shown in detail, but they generally comprise a perforated floor, illustrated in the bottom part in FIGS. 3, 4 and 7 by dashes, or by a network of perforated pipes surmounted by tranquilizers for injecting the raw water uniformly over the entire surface. For further details, the reader may refer to Degrémont's Memento Technique de l'Eau, 9^{th} edition, page 661 et seq.

Means 3 for discharging the treated liquid ET, in the top part of the tank, determine the upper liquid level S in the tank. These discharge means 3 may consist of ducts 4 or perforated pipes, forming a network ensuring uniform uptake of the decanted water.

Such a distribution system maintains an identical water flux at all points in a sludge bed M and avoids any risk of a dead zone. The upper level of the sludge bed in FIG. 3 is denoted by Nh2 and the upward vertical arrows in this figure illustrate the ascensional velocity.

The device D includes a bell 5 closed at the top, which rises above the upper liquid level S in the tank 1 and communicates with the base of the tank, beneath the perforated floor, via an opening 6 (shown schematically). An intake pipe 7 for the liquid to be treated EB opens in to the bell, with its end turned toward the upper part of the bell. A suction means 8, especially a fan or a vacuum pump, is connected to the upper end of the bell 5 to create a partial vacuum when this is necessary. A valve 9 for breaking the vacuum is connected to the upper end of the bell 5 and opens to the atmosphere when it is open. A level detector 10 for detecting the level of liquid in the bell is also provided. All these elements are connected to a control means, advantageously consisting of a programmable controller 11.

The device D includes, in the tank 1, at least one concentrator 12 separated from the rest of the tank by an essentially vertical wall 13 forming a spillway. The upper edge of the spillway 13 determines the sludge spillway level Ld in the sludge concentrator 12.

A siphon 14 is provided for discharging the sludge from the concentrator 12 when it reaches a level Lb below Ld.

According to the invention, the amplitude of the alternating vertical movements of the sludge bed is varied between at least two values: one of these values, which is relatively low, keeps the sludge bed at a low level Nh2 below the spillover level Ld, whereas the other, relatively high, value keeps the sludge bed at a high level Nh1 equal to or above the spillover level Ld, thereby ensuring extraction of some of the sludge and reactants.

To do this, the controller 11 controls at least two types of pulse:
a pulse of type 1 (T₀₁, T₁₁ and ΔH1) called “intense pulse”; and
a pulse of type 2 (T₀₂, T₁₂ and ΔH2) called a “low-intensity” pulse.

As illustrated in FIG. 3, a low-intensity pulse of type 2 corresponds to a drop ΔH2 in the upper liquid level in the bell 5 and varies the top level of the sludge bed so as to reach the level Nh2, without however reaching the height Ld of the spillway 13. These pulses of type 2 allow the sludge bed to breath and enable it to operate optimally without sludge extraction. In FIG. 5, these pulses are shown by the saw teeth 15 of lower amplitude corresponding, in the bell 5, to a rise of the upper level from the height Hb2 to the height Hh2 over a time T₀₂, and to the drop ΔH2 between Hh2 and Hb2 over a time T₁₂. Over the course of the relatively long period of the pulses 15, with no sludge extraction, the reactants concentrate in that portion of the tank alongside the spillway 13. This makes it possible:
to preserve a large mass of reactants within the tank;
to exhaust the reactivity potential of the reactants, and therefore to provide optimum use;
therefore to reduce the dose of the reactants upstream of the reactor for equivalent or higher treatment effectiveness and equivalent or higher effluent quality; and
to increase the reactant concentration within the sludge bed and therefore to increase the buffering power of the sludge bed, thus making the treatment reliable in relation to variations in the quality of the effluent to be treated and/or discrete dosing deficiencies or treatment conditions.

An intense pulse, controlled by the controller 11, is shown by a saw tooth 16 of height greater than the saw teeth 15 in FIG. 5. The rising part of the saw tooth 16 corresponds to the transition of the upper level in the bell 5 from the height Hb1 (equal to Hb2) to the maximum height Hh1 over a time T₀₁, whereas the descending part corresponds to the lowering of the upper level of liquid in the bell 5 from the level Hh1 to the level Hb1 over a time T₁₁.

FIG. 4 illustrates the effect of an intense pulse with the upper level of the sludge bed rising to a height Nh1 equal to or above the level Ld such that sludge spills over into the concentrator 12. A fraction of the sludge, containing spent reactants, the reactivity potential of which has been exhausted, spills over into the concentrator 12.

Advantageously, the controller 11 is programmed to adjust the frequency of the intense pulses of type 1 according to the reactant dose and the residence time that are necessary for exhausting the reactivity of said reactants. According to the example shown in FIG. 5, two intense pulses corresponding to the saw teeth 16 are separated by two less-intense pulses corresponding to the saw teeth 15. The number of less-intensive pulses 15 between two intense pulses 16 is adjusted according to the requirements.

The diagram in FIG. 6 illustrates the instantaneous ascensional velocities corresponding to the diagram of FIG. 5.

These velocities vary from a value V₀ to a maximum value V₁ for the intense pulses (saw teeth 16) and a lower value V₂ for the less-intense pulses (saw teeth 15).

Employing two sets of parameters T₀, T₁ and ΔH advantageously enables the sludge bed homogenization function (FIG. 3) to be disassociated from the sludge extraction function (FIG. 4) with the above-mentioned advantages and benefits.

The invention thus allows greater flexibility in operating the reactors, optimum management of the reactant requirements and therefore lessens the environmental impact of the treatment.

FIG. 7 shows an alternative embodiment of the settling device or reactor Da designed to employ a plurality of reactants, namely two reactants R1, R2 in the example in question, in the sludge bed reactor. The reactant R1 expands less easily than the reactant R2 owing to the density and size thereof. The suction means 8, the valve 9, the detector 10 and the control means 11 have not been shown in FIG. 7, but the device Da is equipped with these elements as in FIGS. 3 and 4.

The tank 1.1 has two spillways 13.1 and 13.2 spaced apart transversely, defining two different spillover height levels Ld1 and Ld2, with Ld1 being below Ld2. Two concentrators 12.1 and 12.2 are thus formed for the reactant R1 and the reactant R2 respectively. A siphon 14.1, 14.2 is associated with each concentrator.

Two reactive zones Z1 and Z2, one above the other, consisting of a mixture of the reactants R1+R2 and of the reactant R2 respectively, are thus formed, the cohesion of which is different and the upper bounds of which are Nh2.1 and Nh2.2 respectively.

A controller constituting the control means, not shown in FIG. 7, is programmed to define four pulse types:
a pulse of type 1a (T₀₁ₐ, T₁₁ₐ and ΔH1a) called “moderately intense” pulse for homogenizing the reactive zone Z1 consisting of a mixture of the reactants R1 and R2 and for varying the upper sludge bed level Nh2.1 without reaching the level Ld1 of the spillway 13.1 and without the level Nh2.2 reaching the level Ld2 of the spillway 13.2;
a pulse of type 2a (T₀₂ₐ, T₁₂ₐ and ΔH2a) called a “less-intense” pulse for homogenizing the reactive zone Z2 consisting of the reactant R2 and for varying the upper level Nh2.2 of this reactive zone Z2 without reaching the level Ld2 of the spillway 13.2 of the sludge concentrator 12.2;

It should be noted that these two pulse types, which may be identical, combine to homogenize the reactive zones Z1 and Z2 without extraction of reactants.
a pulse of type 3 (T₀₃, T₁₃ and ΔH3) called an “intense” pulse for raising the upper level Nh2.2 of the reactive zone Z2 above the level Ld2 of the spillway 13.2 of the concentrator 12.2 so that the reactant R2 selectively spills over into the concentrator 12.2; and
a pulse of type 4 (T₀₄, T₁₄ and ΔH4) called a “very intense” pulse for raising the upper level Nh2.1 of the reactive zone Z1 above the level Ld1 of the spillway 13.1 of the concentrator 12.1 so that a mixture of reactants R1 and R2 spills over into the concentrator 12.1.

The frequency of the type 3 (“intense”) pulses and of the type 4 (“very intense”) pulses will be defined according to the desired residence times for the reactants R1 and R2 in the reactor respectively and according to the exhaustion of the reactivity potential thereof.

During these pulses, the sludge contained in the concentrators 12.1 and 12.2 comprises reactants R1 and R2 and suspended matter possibly contained in the effluent. This sludge may be partially or completely reinjected into the reactor using a recycling device comprising recycling lines 17.1 and 17.2.

As a variant, it is possible to apply an ascensional velocity greater than the entrainment velocity of the reactant R2 so that this reactant will be entrained into the treated effluent, which passes through the channels 4. According to this operating mode, the reactant R2 may then be retained, for example using a membrane filter, so that the reactant R2 is selectively extracted and concentrated without employing a concentrator such as 12.2, thereby simplifying the design and the cost of the reactor.

One particular advantage of this induced stratification is to be able to eliminate the pollution more selectively and to minimize the competing and/or inhibiting reactions between the various pollutants or targets of the treatment and the various reactants.

For example, it may be relevant to use an inexpensive reactant R1 of the active carbon type that will eliminate the organic matter to a large extent and a more expensive reactant R2 of the finer active carbon type intended for pesticide adsorption, but the reactivity of which is reduced in the presence of organic matter by a competing and/or steric hindrance effect. As a result, the quality of the treated element will be improved.

The above example is given with the use of two reactants R1 and R2. However, it should be understood that this example is in no way limiting, in particular in respect of the number of reactants employed.

Other advantages of the present invention are that it:
allows variable energy use best suited to the homogenization of each of the reactive zones;
separates the sludge homogenization function from the sludge extraction function, i.e. controls the residence time of the reactants;
separates and controls the residence times of each reactant independently;
thus optimizes the usage of the reactants, ensuring that the reactivity potential of each reactant has been exhausted;
thus reduces the consumption of reactants and therefore the treatment cost;
increases the mass of reactants immobilized in the reactor and therefore the effectiveness of the buffering power of the reactive zones, that is to say in fine increases the robustness and the reliability of the treatment; and
extracts certain reactants selectively using technical means (selective recycling/regeneration thereof) and therefore to make savings.

Another advantage of the invention is overall reduction in the environmental impact of using the reactants and, consequently, in particular, the reduction in consumption of reactants and the optimized recycling/regeneration of some of said reactants.

Another utilization example is the operation of a reactor according to the invention used with an adsorbent product and a coagulant. When a coagulant is used, the adsorbent particles are intermittently mixed with the floc formed by the coagulant. By changing the pulses it is possible to densify the floc by means of the adsorbent product and thus to reduce the coagulant dose necessary for cohesion of the sludge bed.

Two operating examples are given below.

### EXAMPLE 1

### The Case with Just an Active Carbon

This case corresponds to an operation at a low ascensional velocity, up to 1-2 m/h, relative to the area of the sludge bed and without using a metal salt. The type 2 pulses, termed less-intense pulses, allow the sludge bed to breath. From time to time, more intense type 1 pulses are produced so as to extract the excess adsorbent. This operation mode is used for example in a membrane system and, if a few PAC (powdered active carbon) particles are continuously removed, they are retained by the membrane located downstream.

In this case, the following values are for example adopted: bell-filling time T₀₂ of 20 s (seconds) and T₀₁ of 40 s; expulsion time T₁₂ of 20 s and T₁₁ of 10 s; drop in height ΔH1 of 60 cm and ΔH2 of 40 cm.

### EXAMPLE 2

### The Case of a Reactor with an Active Carbon of 150 μm Mean Diameter and an Active Carbon of 10-20 μm Mean Diameter

In this case, the 150 μm mesopore active carbon is intended for eliminating the OM (organic matter) and the 10-20 μm active carbon is intended for eliminating pesticides.

This complex material may be considered as a powdered active carbon of 150 μm particle size or as granular active carbon of T₅₀ of 0.15 mm.

Fluidization trials carried out with this material gave the results below:

| | | Velocity (m/h) for x % expansion | |
|---|---|---|---|
| T₅₀ | Temperature | For 10% | For 50% |
| (mm) | (° C.) | expansion | expansion |
| 0.15 | 5 | 1.7 | 4.1 |

It was found that at an ascensional velocity of 4 m/h, —the nominal ascensional velocity commonly employed in a pulsed settler—this material had an expansion of 50%.

During expulsion, the ascensional velocity was around 3 times the nominal velocity, i.e. 12 m/h, and during this period the material had a greater than two-fold expansion. This very large expansion of the particles allowed them to be discharged into a sludge concentrator at a suitable level.

In this case, the following values were for example adopted:

| | | | | | | | Type 4 | |
|---|---|---|---|---|---|---|---|---|
| | Type 1a | | Type 2a | | Type 3 | | (very | |
| | (moderate) | | (mild) | | (intense) | | intense) | |
| Filling time (T₀) | 30 | s | 20 | s | 40 | s | 50 | s |
| Expulsion time (T₁) | 10 | s | 20 | s | 7 | s | 5 | s |
| Drop in height ΔH | 60 | cm | 40 | cm | 80 | cm | 100 | cm |

1.-8. (canceled)

9. A settling method using a pulsed sludge bed for the treatment of any type of liquid, particularly water, employing at least one powdered or granular reactant, in which:
the liquid and the reactant(s) for the treatment are contained in a tank comprising, at the base thereof, means for uniformly injecting liquid to be treated over the entire surface thereof;
the treated liquid is discharged into the top portion, at the upper level of the liquid in the tank;
the liquid to be treated is fed into the tank in pulses, causing alternating vertical movements of the sludge bed; and
a portion of the sludge spills over into at least one concentrator when the upper level of the raised sludge bed exceeds a spillover level (Ld), wherein the amplitude of the alternating vertical movements of the sludge bed is varied between at least two values, one of these values corresponding to a high sludge bed level (Nh2) below the spillover level, with discharge of neither sludge nor reactant, and the other of these values corresponding to a high sludge bed level (Nh1) above the spillover level (Ld) with discharge of sludge and reactant.

10. The method as claimed in claim 9, wherein at least two concentrators (12.1, 12.2) are employed with different spillover levels (Ld1, Ld2) in order to create various reactive zones (Z1, Z2) and in that the sludge from the various reactive zones is recovered selectively.

11. A settling device using a pulsed sludge bed for the treatment of any type of liquid, particularly water, employing at least one powdered or granular reactant, comprising:
a tank (1, 1.1) containing the liquid undergoing treatment and the reactant(s);
at the base of the tank, means (2) for uniformly injecting liquid to be treated over the entire surface thereof;
a means (3) for discharging the treated liquid into the top portion of the settler, defining the upper liquid level (S) in the tank;
a bell (5) rising above the liquid level and communicating with the base of the tank;
an inlet pipe (7) for the liquid to be treated, which opens into the bell;
a suction means (8) provided at the top portion of the bell;
a control means for filling the bell with liquid in a filling time (T0) and raising the liquid in the bell to a level (Hh) and for rapidly lowering the level in the bell by an amount (ΔH) over an expulsion time (T1) with an expulsion effect through the sludge bed, which is raised; and
at least one concentrator (12) into which a portion of the sludge spills over when the sludge bed is raised to a level equal to or above the spillover level,
wherein the control means (11) is designed to vary the drop in height in the bell (5) and to give it at least two values (ΔH1; ΔH2), the lower value (ΔH2) of which ensures that the sludge bed is raised to a level (NH2) below the spillover level (Ld) and there is no discharge of sludge and reactant, whereas the higher value (ΔH1) ensures that the sludge bed is raised to a level (NH1) equal to or above the spillover level (Ld) and that there is discharge of sludge and reactant.

12. The settling device as claimed in claim 11, wherein the control means (11) is designed to control:
n filling times of the bell (T₀₁ . . . T₀ₙ);
n expulsion times (T₁₁ . . . T₀ₙ);
n drops in height (ΔH1 . . . ΔHn) within the bell (5); and
n pulsing frequencies.

13. The settling device as claimed in claim 11, further including at least two concentrators (12.1, 12.2) with different spillover levels (Ld1, Ld2) for selectively recovering the sludge from various reactive zones (Z1, Z2).

14. The settling device as claimed in claim 11, wherein the control means is programmed to define four pulse types:
a “moderately intense” pulse, for homogenizing a reactive zone (Z1), consisting of a mixture of the reactants (R1, R2), and for varying the upper sludge bed level (Nh2.1) without reaching the level (Ld1) of the associated spillway (13.1), and without the upper level (Nh2.2) of the other reactive zone (Z2) reaching the level (Ld2) of the associated spillway (13.2);
a “less-intense” pulse for homogenizing the reactive zone (Z2) and for varying the upper level (Nh2.2) of this reactive zone (Z2), without reaching the level (Ld2) of the associated spillway (13.2);
an “intense” pulse for raising the upper level (Nh2.2) of the reactive zone (Z2) above the level (Ld2) of the associated spillway (13.2) so that the reactant (R2) selectively spills over into the associated concentrator (12.2); and
a “very intense” pulse for raising the upper level (Nh2.1) of the reactive zone (Z1) above the level (Ld1) of the associated spillway (13.1) so that a mixture of reactants (R1, R2) spills over into the associated concentrator (12.1).

15. The device as claimed in claim 11, wherein the control means is programmed to apply a pulse generating an ascensional velocity above the entrainment velocity of the reactant (R2) so that this reactant is entrained in the treated effluent, the reactant (R2) then being retained by filtration on a membrane, so that the reactant (R2) is selectively extracted and concentrated.

16. The settling device as claimed in claim 11, further comprising a recycling means (17.1, 17.2), in the tank, or upstream thereof, for recycling the sludge coming from the concentrator(s).
